(19) United States
(12) Patent Application Publication
(10) Pub. No.: US 2008/0052623 A1
(43) Pub. Date: Feb. 28, 2008

(54) Accessing data objects based on attribute data

(76) Inventor: Michael Gutfleisch, Wiesloch (DE)

Correspondence Address: KENYON & KENYON LLP, 1500 K STREET N.W., WASHINGTON, DC, 20005, US

(21) Appl. No.: 11/508,804

(22) Filed: Aug. 22, 2006

(51) Int. Cl. G06F 3/00

(52) U.S. Cl. 715/713; 715/810

(57) ABSTRACT

A method and device for accessing data objects includes the receipt of a first attribute selection. This may be received by a processing device from an input device. Based on this attribute selection, the method and device dynamically generates a first hierarchical display which includes a visual display of data objects based on the selected attribute. The method and device further receives a second attribute selection and thereby dynamically generates a second level hierarchical display of data objects based on the second attribute selection. Thereby, a virtual folder structure is dynamically created by the selection of the attribute data to define the folder structure and subsequently allow interfacing with stored data objects.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND

The present invention relates generally to a data object categorization and more specifically to the storage and subsequent retrieval of data objects based on attributes of the data object itself.

In existing data storage and retrieval systems, data objects are stored in sequential predefined categories. The most common storage technique of data objects is folder-based storage, where the data objects may include data files, applications, notes, folders and any other suitable type of electronically stored element or component. In the existing folder technique, hierarchies of folders may be either predefined or user defined. It is through this known sequencing operation that the data object can be subsequently retrieved. One typical example is in a visual computing environment with a graphical user interface illustrating actual file folders or other icons with associated text. The user can then physically navigate these folders to find or store a file.

There are numerous problems with the existing folder technique. One such problem is the static nature of the hierarchy. This static structure typically requires knowledge of the folder and sub-folder sequences. For a data object to be stored in a particular location, the user must navigate to the root directory and then through the various folders and sub-folders. Thus, in order to retrieve the same data object, the original user or other users seeking the data object must recreate the navigation. Thus, the root-folder-sub-folder sequence must be commonly known.

As generally recognized, a common solution is to attempt to standardize folder-naming approaches to assist the user-navigation. Although, this can be problematic because it locks the storage into a defined sequence. For instance, in a business application a storage hierarchy may be based on a root of a department (e.g. sales), with folders for various clients and sub-folders for different transactions with the client. In these specific folders, data objects relating to the transactions can be stored. If a user wished to examine data objects based on a type of transaction, the current folder hierarchy complicates this task.

Search engines reduce complications with static folder hierarchies, but are limited based on existing attributes associated with data objects, such as file names, creation dates, creating entities, for example. Search engines also only reduce complications with data object retrieval, but still require the user to follow the known sequence for data storage.

Another common technique for data object storage, and allowing for subsequent retrieval includes using a general document storage system. This storage system provides a general database where documents are stored based on characteristic information that a user may enter during storage operations. From this characteristic information, an interface conducts a search of the database and retrieves corresponding data objects.

This existing technique provides an easy solution to data retrieval and storage issues, but complicates processing operations by requiring a full second application level to access the information through the user interface. Therefore, the database technique includes additional processing overhead and limits the access to the data objects based on how the search results can be assembled. Additionally, the data retrieval is limited in the database application to the available characteristic data associated with the files, providing a limited entry point to finding these data objects.

Another approach includes the storage of data objects with attribute data in a Business Warehouse as available from SAP. Although, the Business Warehouse is also limited because attribute data is used for analytical purposes and not storage categorization operations.

In addition to the storage of data, retrieval of data in a graphical user interface can be complicated by the visual display of folder structures and data objects. Existing graphical displays illustrate in a window display the folder structure, where this display is also static based on the existing defined folder patterns. The above-mentioned problems with storing and accessing data are also found in the visual display of the folder structure. In order to store the data objects and subsequently retrieval, the user navigates the static folder structure.

### BRIEF DESCRIPTION OF THE DRAWINGS

FIG. 1 illustrates one embodiment of a processing system providing for accessing data objects having attribute data associated therewith;

FIG. 2 illustrates a representative screen shot of one embodiment of a user interface for accessing data objects based on attribute data;

FIG. 3 illustrates a sample table of attribute data associated with data objects, where the attribute data is usable for accessing selected data objects;

FIGS. 4-7 illustrates other representative screen shots of various embodiments of a user interface for accessing data objects based on attribute data;

FIG. 8 illustrates block diagram of one embodiment of a device for accessing a data object based on attribute data;

FIG. 9 illustrates a flowchart of the steps of one embodiment of a method for accessing data objects based on attribute data; and

FIG. 10 illustrates a flowchart of the steps of one embodiment of a user interface method.

### DETAILED DESCRIPTION

The disposition of virtual folders allows for the dynamic generation of a user interface for finding and accessing data objects in an expedited manner. Data objects are stored in one or more storage locations and are indexed or catalogued based on attribute data. In a typical embodiment, a user saving the data object or an application creating the document generates the attribute data describing the data object. Through a novel user interface, a user dynamically generates the folder structure for data object and data object classifications. Based on a root node, a user can manually select an attribute associated with the data objects. From this attribute selection, folders are dynamically created having the data objects therein. The folders may include further levels of data object refinement, including second or further sub-layers of data object selection based on the attribute selection process.

FIG. 1 illustrates one embodiment of an apparatus 100 providing for the access of data objects being displayed in a virtual folder interface. The apparatus 100 includes an input device 102, an output device 104, a processing device 106 including a receiver 108 and a generator 110, and a storage database 112. Further illustrated in FIG. 1, the input 102 and the output 104 are accessible by a user 114.

The input device 102 and the output device 104 may be any suitable device or devices capable of providing user input and output functionalities. For example, the input device 102 may be a keyboard, mouse or other tactile device and the output device 104 may be a display device.

The processing device 106 may be one or more processing elements, as recognized by one having ordinary skill in the art, providing for various levels of computational processing. The device 106 is illustrated as having two processing components, 108 and 110, which may be implemented in hardware, software or a combination thereof. The device 106 may operate software providing for systems operations, such as a desktop or platform application including any number of processing components or modules. In addition, the device 106 may be one or more local or remote processing components operative to generate a processing environment, where the processing device 106 performs various operations in response to executable instructions. It is recognized that the processing device 106 includes many additional processing modules, components and elements that have been omitted for clarity purposes only.

Further illustrated in FIG. 1, the processing device 106 is coupled to a storage database 112. This storage database 112 may be a local or a remote storage device operative to store data objects and attribute data therein. As described in further detail below, the attribute data correlates to various attributes of the data objects. The storage database 112 may also be composed of one or more storage devices.

In the apparatus 100 of FIG. 1, the user 114 may operate the processing device 106 in normal operations using the input device 102 and the output device 104. Although, in one embodiment, the user may utilize the receiver 108 and the generator 110 when attempting to locate a data object using a browser or other user interface environment. For example, the user may activate the receiver 108 with an input command from the input device or a hot-key or menu command from within an application, such as an open-file command.

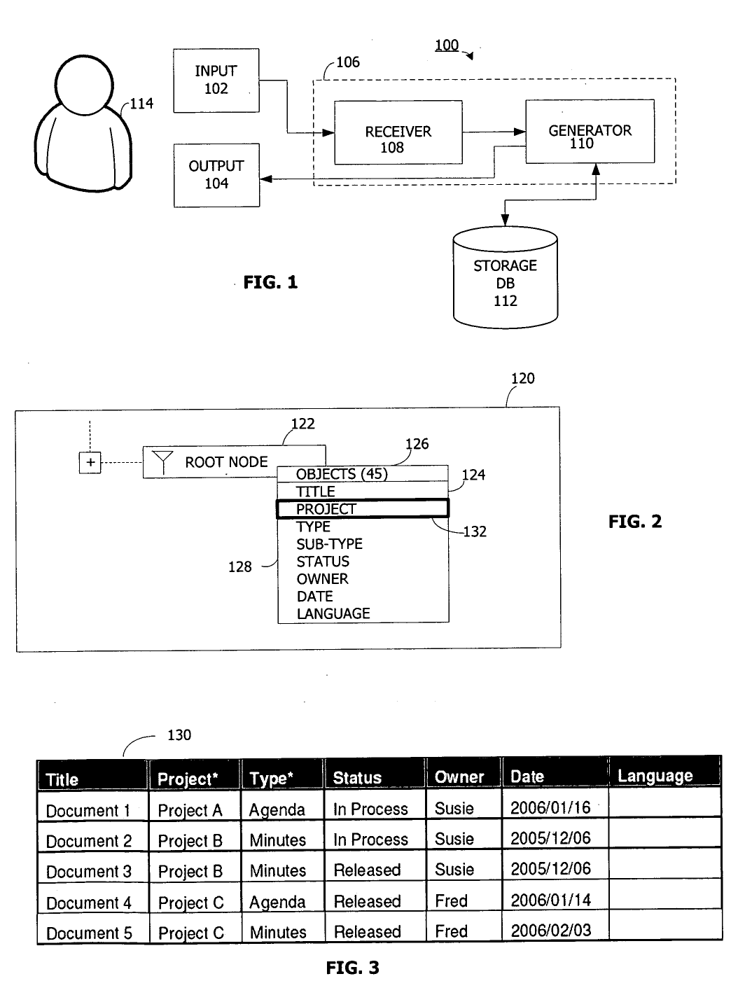

In one embodiment, the processing device 106 provides a visual display of a root node indicating a starting point for a visual virtual folder structure. FIG. 2 illustrates one exemplary display 120 of a root node. Through the input device 102, the user 114 may activate an attribute selection menu 124 of FIG. 2. The user 114 may thereupon make an attribute selection, which may include selecting one of the attributes listed in the menu. In the example of FIG. 2, the menu 124 includes a header field 126 indicating the root node has a certain number of data objects and the listed attributes 128.

In one embodiment, the listed attributes 128 may be stored in an attribute table or other type of data structure in a storage device, such as the storage device 112 of FIG. 1. FIG. 3 illustrates an exemplary attribute table 130 illustrating various attributes for different data objects. In this example, the data objects are different types of documents for different projects generated by different users on different dates. It is recognized that any suitable number of attributes, such as but not limited to the exemplary ones listed in FIG. 3 of Title, Project, Type, Status, Owner, Date and Language, may be used. These attributes of the table 130 describe the attributes of the corresponding data objects stored in the storage database 112, where in one embodiment, the attributes are user-defined when a user saves a particular document on the storage device, or in another embodiment the attributes may be automatically assigned by a user folder selection operation as described in further detail below as it relates to opening virtual folders or may be generated by a software application or other module used to generate, modify or save the data object.

Referring back to FIG. 1, the receiver 108 is thereupon operative to receive the first attribute selection, which may be through a visual input queue, such as the shadowed selection box 132 of the exemplary display 120 of FIG. 2. In one embodiment, this first attribute selection may indicate the selected attribute off of the root node such that the generator 110 may thereupon access the storage database 112 using this information.

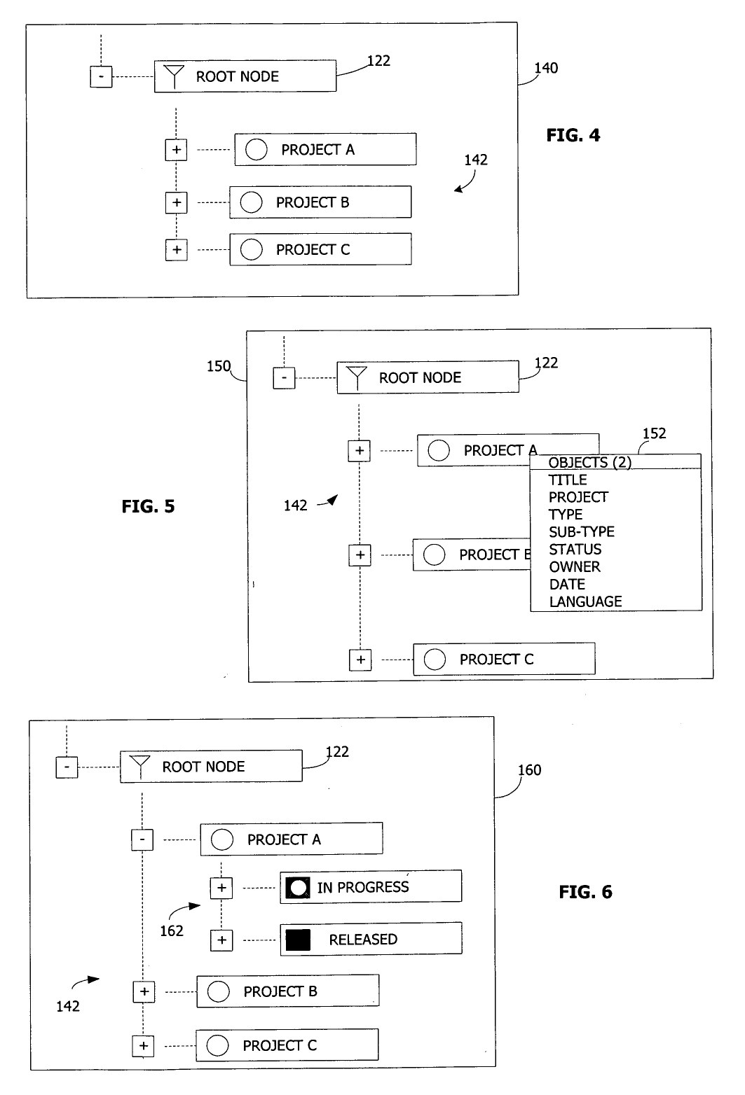

The generator 110 is operative to thereupon dynamically generate a first hierarchical display based on this attribute selection. This first hierarchical display includes a virtual folder display based on the association of data objects by the corresponding selected attribute. Using the example of attribute selection 132 of FIG. 2, FIG. 4 illustrates a sample hierarchical display 140 including the root node 122 and folders 142. In the exemplary embodiment, the storage database 112 includes data objects having attribute data indicating three different projects (A, B and C). It is recognized that any suitable number of projects may be designated, thereby providing a virtual display 140 of more or less header fields 142 based on the attribute selection. As illustrated in FIG. 4, the folder header fields are cascaded within the root node 122, in the embodiment using a dashed line indicator and commonly used plus or minus box indicators to indicate whether a cascading folder is visually opened or closed.

Referring back to FIG. 1, the generator 110 provides the first hierarchical display (such as the display 140 of FIG. 4) to the output device 104. This output device 104 provides the user 114 the visual display of the first hierarchical virtual folder based on the user-selected attribute data. In one embodiment, the user 114 may thereupon provide an input command to receive another attribute selection window. For example, in one embodiment, the user may right-click on a mouse or click the mouse with a designated keyboard key depressed for the second attribute selection window to appear.

FIG. 5 illustrates an exemplary display 150 including cascaded display 140 of FIG. 4 with an attribute selection field 152. Similar to the attribute selection field 124 of FIG. 2, this field 152 includes the available types of attribute details of the data objects and a summary listing of the objects in the designated folder 142, in this example “Project A.”

Referring back to FIG. 1, using the input device 102, the user 114 selects a particular attribute such that the receiver 108 receives the second attribute selection. Similar to the operations described above with the first attribute selection, the receiver 108 provides the selection to the generator 110 which thereupon access the storage database 112. In one embodiment, the generators 110 access the attribute table, such as table 130 of FIG. 2. In another embodiment, the generator 110 may compile the information through a searching operation or other technique.

The generator 110 is thereupon operative to dynamically generate a second level hierarchical display of data objects based on the second attribute selection. FIG. 6 illustrates an exemplary display 160 including the root node 122, the first hierarchical display folders 142 and the display of data objects 162, which in this example is based on the attribute of status. Therefore, in this embodiment, the data object is a folder of further data objects attributed to Project A having either an in progress status or a released status. In this virtual folder display, a user may manually select the data object to open the menu and thereupon see the actual objects in these categories. For example, the in progress objects may be design specifications and the released objects may be white papers that have been publicly disclosed.

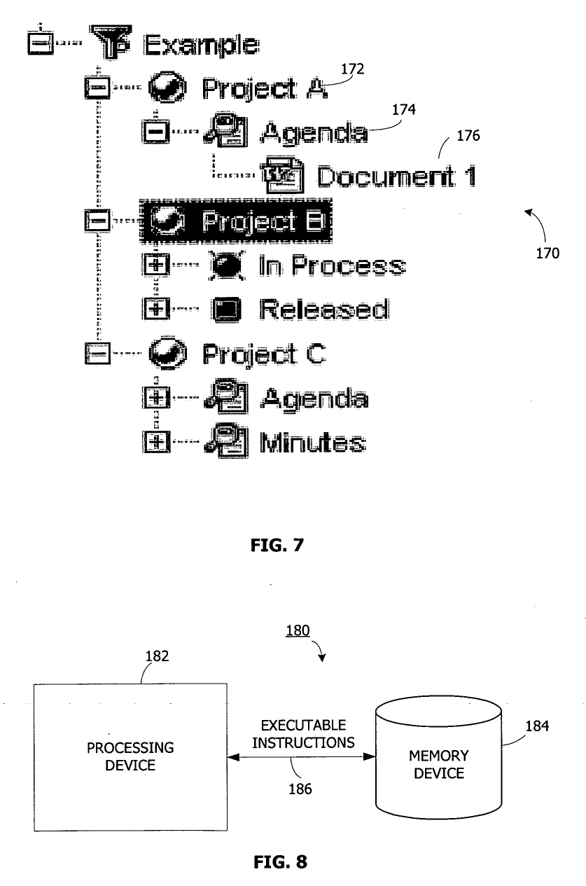

FIG. 7 illustrates another exemplary virtual folder display 170. The display of data objects and folders in the virtual folder display includes two components. A first component is an icon or other graphical element. A second component is a text field. The graphical component may provide a visual indication of the type of data object or a status of the data object.

In this sample display, project A 172 includes the text “project A” and the graphical icon of a button or sphere. Cascading from this sub-root level folder, where the root level is “Example,” is a breakdown of objects based on the selected document type, which includes the single type of “Agenda” 174. This header includes the text “agenda” and the graphical icon of a piece of paper and a magnify glass. Further cascaded in this virtual folder display is the single object, which in this case is a word processing document, including the text of a file name and a word processing document icon.

In the highlighted example of Project B, the icons for the sub-category of data objects of “In process” and “released” include the graphical icons indicating a stop status for the in process elements and a go status for released documents. As recognized by one having ordinary skill in the art, the illustrated graphical icons in the sample displays 160 and 170 of FIGS. 6 and 7 are for exemplary purposes only and are not meant to be so limiting as disclosed herein.

As also visible in the sample screen 170, the virtual folder display may also include a third-level of hierarchical display. This may include receipt of a third attribute selection and the generation of the third display. In another embodiment, this may include simply activating the visual user interface icon to expand the data object, which in this embodiment is a folder, to reveal the additional data objects encompassed therein.

FIG. 8 illustrates a graphical representation a processing system 180 includes a processing device 182, a memory device 184 and executable instructions stored therein, the instructions receivable by the processing device 182. The processing device 182 may be one or more processing devices operative to perform various processing operations in response to the executable instructions. In one embodiment, the processing device 182 may perform operations including those as described above with regard to the processing device 106 of FIG. 1.

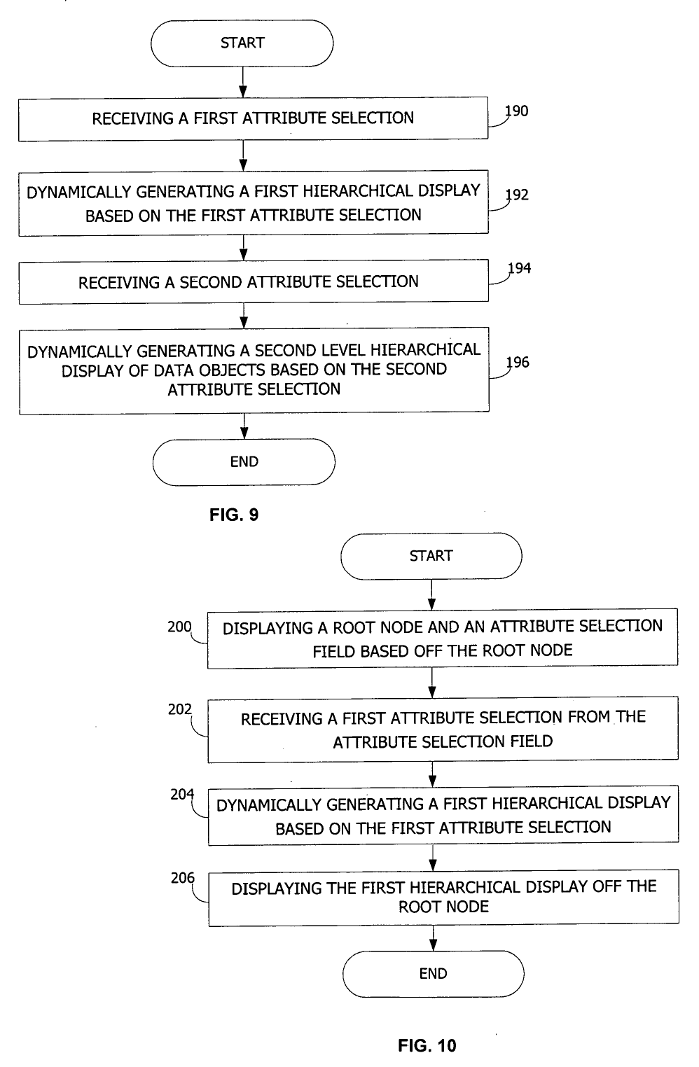

FIG. 9 illustrates a flowchart of the steps of one embodiment of a method for accessing data objects having attribute data associated therewith. The processing device 182 of FIG. 8 may be operative to electronically perform these steps in response to the executable instructions 186 received from the memory device 184. In one embodiment, the method begins, step 190, by receiving a first attribute selection. For example, FIG. 2 illustrates the attribute selection 132 of the attribute “project” of the corresponding data objects. In the exemplary embodiment illustrated in FIG. 2, the attribute selection field is based off the root node 122.

The next step, step 192, is dynamically generating a first hierarchical display based on the first attribute selection. FIG. 3 illustrates an example of the hierarchical display 142 based on the selected attribute “project” 132 of FIG. 2. The next step, step 194, is receiving a second attribute selection. Similar to the first attribute selection, this may be received through an input device by a user providing the selection. FIG. 5 illustrates an example of a second attribute selection display including the attribute data associated with data objects. In this exemplary embodiment, the second attribute selection field is visually based off the selected data object, which in FIG. 5 is the “project A” header.

The next step, step 196, is dynamically generating a second level hierarchical display of data objects based on the second attribute selection. FIG. 6 illustrates a sample second level display 162 of projects as based on the attribute data of “status.” In the embodiment of FIG. 6, the second hierarchical display is cascaded within the first hierarchical display. Further embodiments may include displaying status-indicator icons, such as the icons visible in FIGS. 6 and 7 next to text fields in the header. Thereupon, in one embodiment, this method for accessing data objects is complete.

FIG. 10 illustrates a flowchart of the steps of one embodiment of a user interface method. This method may be performed by a processing device in response to executable instructions. Additionally, the operation of this method may be in conjunction with existing operating system software applications, providing the user interface in conjunction with normal operating system operations.

In one embodiment, the method begins, step 200, by displaying a root node and an attribute selection field based off the root node. By way of example, FIG. 2 illustrates a visual display of a root node 122 and an attribute selection field 124 based off the root node. The attribute selection field 124 includes attribute data that describes attributes of data objects stored in one or more storage locations and accessible by the operating system running the interface.

The next step, step 202, is receiving a first attribute selection from the attribute selection field. This step may be performed by a receiver, such as the receiver 108 of the processing device 106 in FIG. 1. The attribute selection may be generated by a user interfacing with the operating system. The next step, step 204, is dynamically generating a first hierarchical display based on the first attribute selection, similar to the operations of step 192 of the flowchart of FIG. 9.

The next step, step 206, is displaying the first hierarchical display off the root node. FIG. 4 illustrates an exemplary embodiment of the first hierarchical display 142 of data objects, which in the example are folders, based off the root node 122, where the data objects are selected based on the attribute selection 132 of exemplary display of FIG. 2. Thereupon, in this embodiment, the method is complete. In this method, other embodiments may include generating and displaying further levels of data objects based on selected attribute data, where these further level data objects may be displayed in a cascading fashion, such as illustrated in the exemplary display 170 of FIG. 7.

Through the utilization of attribute data attributed data objects, a new user interfacing technique allows for the dynamic generation of virtual folders. Instead of previous systems that require user-defined static folder set-ups, virtual folders can be dynamically created. This dynamic creation allows for improved ease of access to retrieving sought after data objects. Additionally, the dynamic creation of virtual folders improves a user's ability to quickly and efficiently save data objects, as these objects are saved in a general database or other central storage system based on the assigned attributes, thereby eliminating a user from having to additionally navigate the static folder set-ups to find the proper location for storing documents. Another benefit can be realized by allowing vertical access to documents, which may not have been available before, such as viewing all data objects of a certain type in a single folder, whereas static folders require the user to navigate to each individual folder to find the corresponding data objects. In addition to the data object saving and retrieval improvements, the user interface and method and apparatus for accessing data objects operating directly within existing operating systems, thereby not requiring additional levels of object searching and retrieval applications.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A method for accessing data objects having attribute data associated therewith, the method comprising:
receiving a first attribute selection;
dynamically generating a first hierarchical display based on the first attribute selection;
receiving a second attribute selection; and
dynamically generating a second level hierarchical display of data objects based on the second attribute selection.

2. The method of claim 1 wherein the second level hierarchical display is cascaded within the first hierarchical display.

3. The method of claim 1 further comprising:
displaying an attribute selection field based off a root node whereupon the first attribute selection is received from this selection field and the first hierarchical display is based off the root node.

4. The method of claim 3 further comprising:
displaying a second attribute selection field based off a selected data object in the first hierarchical display whereupon the second user attribute selection is received from this selection field and the second hierarchical display is based off the selected data object.

5. The method of claim 1 further comprising:
displaying a status-indicator icon adjacent to a textual descriptor of the data object.

6. The method of claim 1 further comprising:
upon receipt of the first attribute section, accessing a storage database to retrieve active links to the plurality data objects including the selected attribute.

7. The method of claim 1 further comprising:
receiving a third attribute selection; and
dynamically generating a third level hierarchical display cascaded within the second hierarchical display of data objects based on the third attribute selection.

8. A data object accessing device, where the data objects have attribute data associated therewith, the device comprising:
a memory device having a plurality of executable instructions stored therein; and
a processing device receiving the executable instructions from the memory device, the processing device, in response to the executable instructions, operative to:
receive a first attribute selection;
dynamically generate a first hierarchical display based on the first attribute selection;
receive a second attribute selection; and
dynamically generate a second level hierarchical display of data objects based on the second attribute selection.

9. The data object accessing device of claim 8 wherein the second level hierarchical display is cascaded within the first hierarchical display.

10. The data object accessing device of claim 8 further comprising:
an output device coupled to the processing device; and
the processing device, in response to the executable instructions, is further operative to display, on the output device, an attribute selection field based off a root node whereupon the first attribute selection is received from this selection field and the first hierarchical display is based off the root node.

11. The data object accessing device of claim 10, wherein the processing device, in response to the executable instructions, is further operative to display, on the output device, a second attribute selection field based off a selected data object in the first hierarchical display whereupon the second user attribute selection is received from this selection field and the second hierarchical display is based off the selected data object.

12. The data object accessing device of claim 8 further comprising:
an output device coupled to the processing device; and
the processing device, in response to the executable instructions, is further operative to display, on the output device, a status-indicator icon adjacent to a textual descriptor of the data object.

13. The data object accessing device of claim 8 further comprising:
a storage database having the plurality of data objects stored therein; and
the processing device, in response to the executable instructions, is further operative to, upon receipt of the first attribute selection, access a storage database to retrieve active links to the plurality data objects including the selected attribute.

14. The data object accessing device of claim 8 wherein the processing device, in response to the executable instructions, is further operative to:
receive a third attribute selection; and
dynamically generate a third level hierarchical display cascaded within the second hierarchical display of data objects based on the third attribute selection.

15. A user interface method comprising:
displaying a root node;
displaying an attribute selection field based off the root node;
receiving a first attribute selection from the attribute selection field;
dynamically generating a first hierarchical display based on the first attribute selection;
displaying the first hierarchical display off the root node;

16. The user interface method of claim 15 further comprising:
displaying a second attribute selection field based off a selected data object in the first hierarchical display;
receiving a second attribute selection from the second attribute selection field; and
dynamically generating a second level hierarchical display of data objects based on the second attribute selection.

17. The method of claim 16 further comprising:
receiving a third attribute selection; and
dynamically generating a third level hierarchical display cascaded within the second hierarchical display of data objects based on the third attribute selection.

18. The method of claim 16 wherein the second level hierarchical display is cascaded within the first hierarchical display.

19. The method of claim 15 further comprising:
displaying a status-indicator icon adjacent to a textual descriptor of the data object.

20. The method of claim 15 further comprising:
upon receipt of the first attribute selection, accessing a storage database to retrieve active links to the plurality data objects including the selected attribute.
